(19) United States
(12) Patent Application Publication
(10) Pub. No.: US 2006/0290667 A1
(43) Pub. Date: Dec. 28, 2006

(54) Multi-function laser pointer mouse

(75) Inventors: Felix Guerra JR., Sijhih City (TW); Chin-Sheng Liu, Sijhih City (TW); Huey-Jiun Huang, Sijhih City (TW); Hung-Chien Huang, Sijhih City (TW)

Correspondence Address: BIRCH STEWART KOLASCH & BIRCH, PO BOX 747, FALLS CHURCH, VA, 22040-0747, US

(73) Assignee: Behavior Tech Computer Corp.

(21) Appl. No.: 11/471,603

(22) Filed: Jun. 21, 2006

(30) Foreign Application Priority Data
Jun. 22, 2005 (TW) 94120717

(51) Int. Cl. G09G 5/08

(52) U.S. Cl. 345/157

(57) ABSTRACT

This invention discloses a multi-function laser pointer mouse which contains a main body, left button, right button, cursor controller, at least one document scrolling control button, and at least one volume control button. The left button and right button are placed on the front side of the main body. The cursor controller is placed in the lower middle position between the left button and the right button of the main body. The document scrolling control buttons are placed in the lower position of the cursor controller of the main body. The volume control buttons are placed on the main body.

### RELATED APPLICATIONS

The present application is based on, and claims priority from, Taiwan Application Serial Number 94120717, filed Jun. 22, 2005, the disclosure of which is hereby incorporated by reference herein in its entirety.

### BACKGROUND

1. Field of Invention

The present invention relates to a laser pointer mouse. More particularly, the present invention relates to a multi-function laser pointer mouse.

2. Description of Related Art

The design concept of conventional laser pointer mouse is a wireless mouse function with remote control molding. The essence of a conventional laser pointer mouse is still a mouse, and the operational target is a computer. Because of the limits of the conventional laser pointer mouse functions, the ability to control the volume and document scrolling is limited.

Seeing the defects of conventional laser pointer mouse, it is important to improve the laser pointer mouse to contain document scrolling functions, remote control functions, timing functions and laser pointer functions.

### SUMMARY

It is therefore an aspect of the present invention to provide an artistic, modern, and ergonomic laser pointer mouse which at least contains a wireless mouse, document scrolling functions, remote control functions, timing functions, and volume control functions.

According to one preferred embodiment of the present invention, a multi-function laser pointer mouse contains a main body; a left button and a right button are respectively placed on the front side of the main body. A cursor controller is placed close to the lower middle position between the left button and right button of the main body. At least one brief control button is placed near the lower position of the cursor controller of main body. Volume control buttons are disposed on the main body.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of a front view of a multi-function laser pointer mouse of one preferred embodiment of the present invention;

FIG. 2 is a schematic diagram of a front view of a multi-function laser pointer mouse of another preferred embodiment of the present invention;

FIG. 3 is a schematic diagram of a side view of a multi-function laser pointer mouse of one preferred embodiment of the present invention;

FIG. 4 is a schematic diagram of another side view of a multi-function laser pointer mouse of one preferred embodiment of the present invention;

FIG. 5 is a schematic diagram of a bottom view of a multi-function laser pointer mouse of one preferred embodiment of the present invention;

FIG. 6 is a schematic diagram of a bottom view of a multi-function laser pointer mouse bottom structure of another preferred embodiment of the present invention;

FIG. 7 is a schematic diagram of a front view of a multi-function laser pointer mouse of variedly preferred embodiment of the present invention;

FIG. 8 is a schematic diagram of a side view of a multi-function laser pointer mouse of variedly preferred embodiment of the present invention.

### DESCRIPTION OF THE PREFERRED EMBODIMENTS

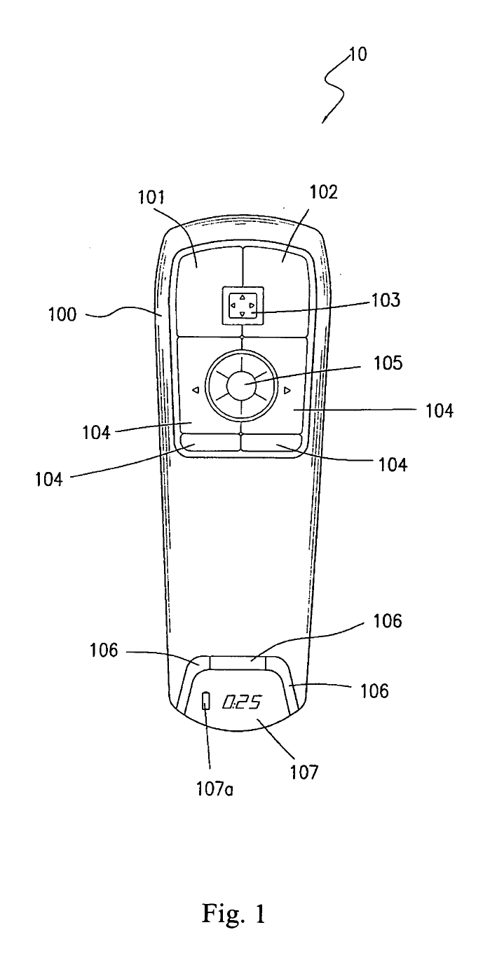

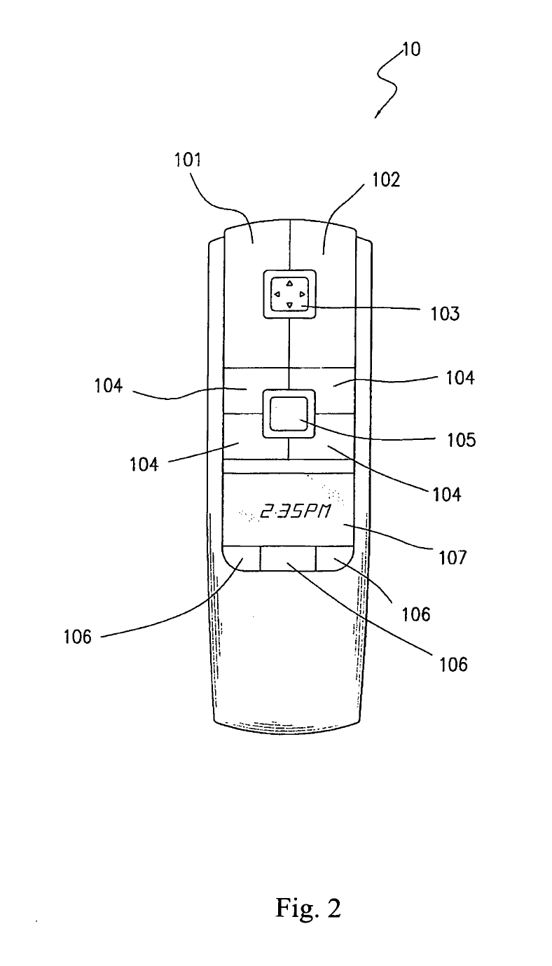

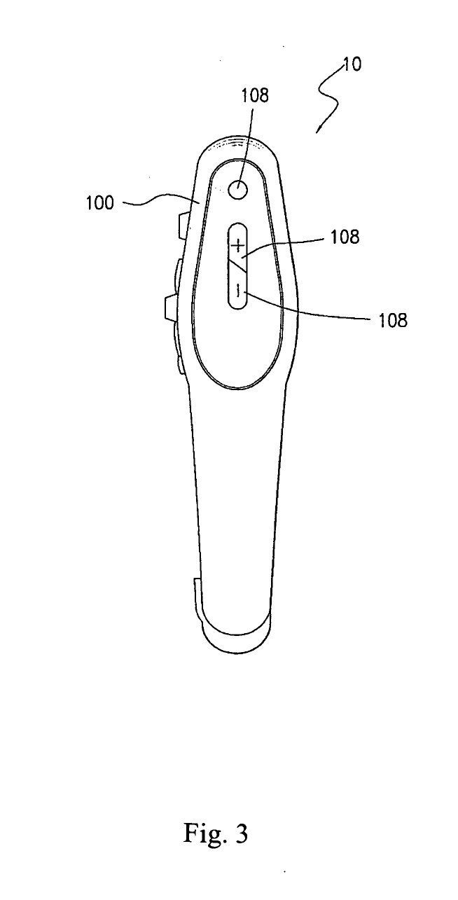

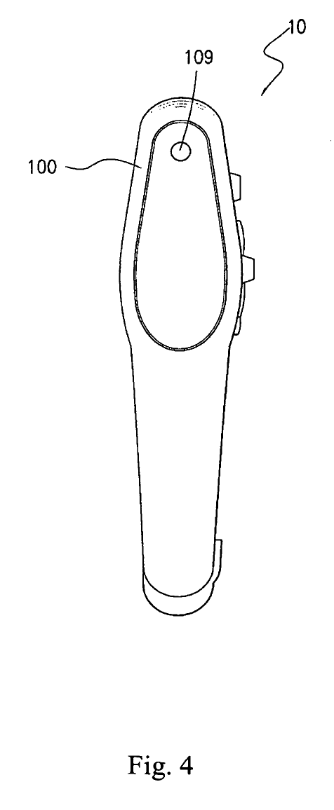

FIG. 1 is a schematic of a front view of a multi-function laser pointer mouse. FIG. 2 is a schematic of a front view of a multi-function laser pointer mouse of another preferred embodiment of the present invention. FIG. 3 and FIG. 4 are schematic side views of a multi-function laser pointer mouse. Besides a wireless mouse function, the multi-function laser pointer mouse 10 provides both remote control document scrolling functions and the laser pointer function. The multi-function laser pointer mouse 10 is ergonomically designed, and therefore the main body 100 is easy to grip in a hand. Buttons disposed on the main body 100 are also easily controlled. The main body 100 may be a rectangular shape, and the thickness and degree of the surface radian have to consider the comfort of the grip in a hand and ergonomics.

In FIG. 1 and FIG. 2, a left button 101 and a right button 102 are placed on the front side of the main body 100. A cursor controller 103 is placed near the lower middle position between the left button and right button of the main body. The left button 101 and a right button 102 are provided to respectively function as a left mouse button and a right mouse button. The cursor controller 103 is provided to control a cursor and may use a multi-direction arrow key switch or a trackball.

At least one document scrolling control button 104 is placed in the lower position of a cursor controller 103 of a main body, and used to control document scrolling. For example, the document scrolling control buttons 104 may be a next page button, a previous page button, a stop/pause button, and a screen switch button. A brief (ex. power point file) can be easily controlled, if a speaker uses the document scrolling control buttons 104.

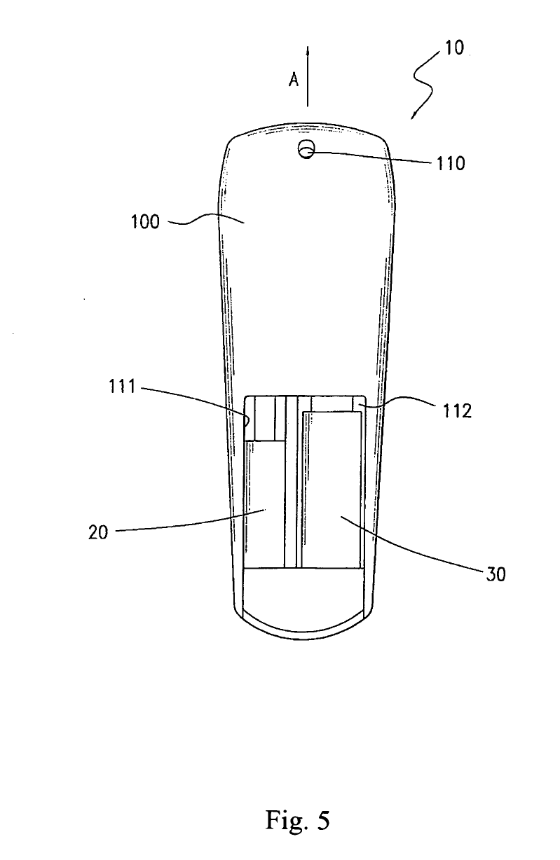

In FIG. 3, at least one volume control button 108 is placed on the side of the main body 100. The volume control buttons 108 may be a volume up button, a volume down button, and a mute button. In FIG. 4, the power switch button 109 is placed on the opposite side of the volume control button 108. The multi-function laser pointer mouse 10 further comprises a display screen 107 and at least one timing function control button 106. Please refer to FIG. 1 and FIG. 2 the display screen 107 and those buttons 106 are placed on the rear position of the front side of the main body. The display screen 107 is used to display the timing, and the timing function control buttons 106 are used to setup up and operate the timing function. It should be understood that the multi-function laser pointer mouse 10 provides the timing function, so that the speaker has an idea of how long the presentation has taken. The display screen 107 further comprises showing the remaining battery capacity signal (refer to FIG. 5), so that the speaker knows the remaining capacity of the battery 30.

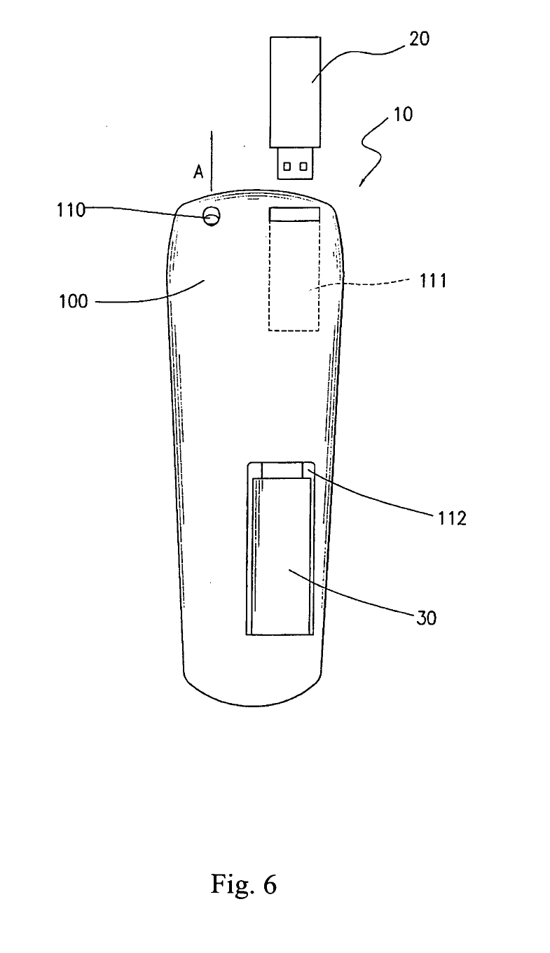

FIG. 5 is a schematic of a bottom view of a multi-function laser pointer mouse and FIG. 6 is a schematic of a bottom view of a multi-function laser pointer mouse bottom structure of another preferred embodiment of the present invention. A laser diode 110 is placed on the front position on the bottom side of the main body 100. Refer to FIG. 5 and FIG. 6, the laser diode 110 can emit a laser beam, and an arrow is used as representation of a laser beam. The laser beam is used to point out the document, and enhance the impression of the speech. Referring to FIG. 1 and FIG. 2, a laser switch button 105 is placed on the center position of the document scrolling control buttons 104. The laser switch button 105 is used to control the laser diode 110 when emitting the laser beam. The speaker presses the laser switch button 105 to control the laser diode 110 in the multi-function laser pointer mouse 10 and to emit the laser beam.

Refer to FIG. 5 and FIG. 6. For wireless functions, the multi-function laser pointer mouse 10 further comprises a wireless receiver 20. A space 111 for storing the wireless receiver 20 is configured at the front on the bottom side of the main body 100 or at the rear on the bottom side of the main body. Moreover, a battery storage space 112 for storing a battery 30 is placed on the bottom side of the main body 100.

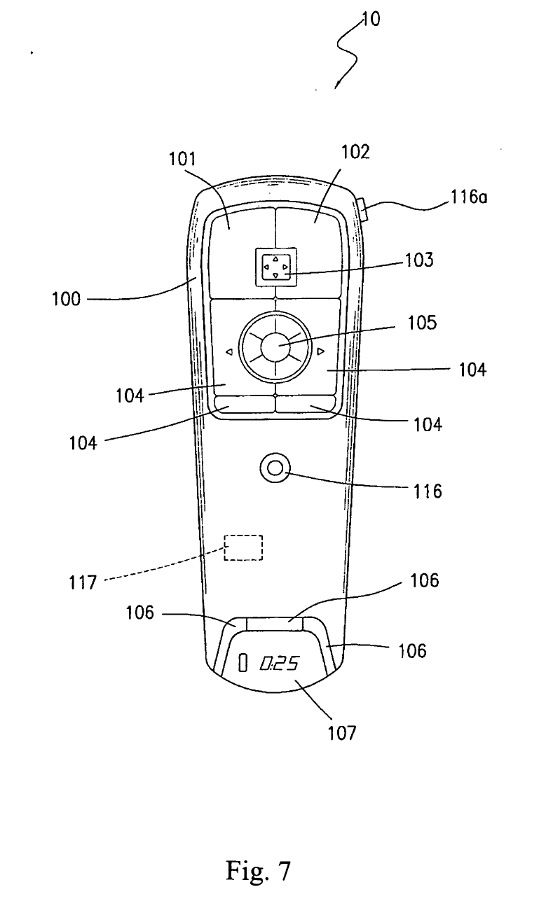

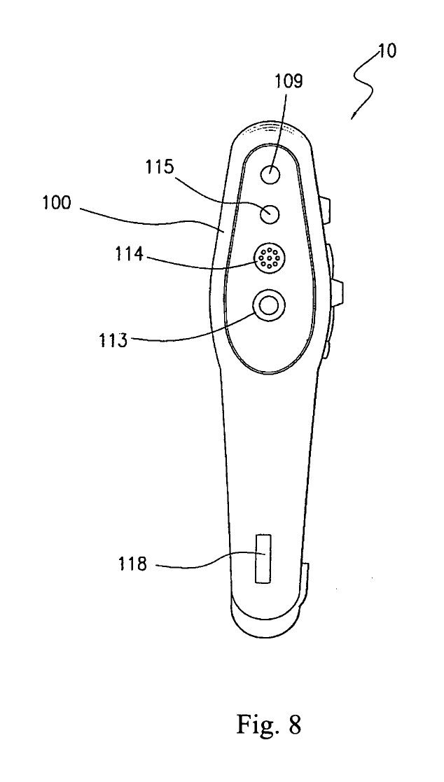

Moreover, the multi-function laser pointer mouse 10 may also have additional functions including a voice recorder, a digital camera, and a USB connecter. FIG. 7 is a schematic of a front view of a multi-function laser pointer mouse of a variation of a preferred embodiment of the present invention, and FIG. 8 is a schematic side view of a multi-function laser pointer mouse of a variation of a preferred embodiment of the present invention. A sound output connecter 113 is placed on a side of the main body 100. The sound output connecter 113 may be an earphone jack. An internal microphone 114 and a recorder button 115 may also be placed on the same side as the sound output connecter 113. When the speaker presses the recorder button 115, the multi-function laser pointer mouse 10 initiates the recording function, and records the sound signal in the memory 118. An internal digital camera 116 is placed on the front side of the main body 100, and is operated using a shutter button 116a. A USB connecter 117 is placed on the side of the main body 100, and the USB connecter 117 may conform to the OTG (On-The-Go) standard.

The multi-function laser pointer mouse is artistic, modern, and ergonomic. Moreover, the multi-function laser pointer mouse of the present invention contains wireless mouse, brief remote control, timing, laser pointer, voice recorder, digital camera, and USB connecter functions. These functions improve and enhance the laser pointer mouse.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multi-function laser pointer mouse comprising:
a main body;
a left button and a right button placed on the front side of the main body;
a cursor controller placed near the lower middle position between the left button and the right button of the main body;
at least one document scrolling control button placed near the lower position of the cursor controller of the main body; and
at least one volume control button placed on the main body.

2. The multi-function laser pointer mouse of claim 1, wherein the multi-function laser pointer mouse further comprises:
a display screen capable of displaying timing; and
at least one timing function control button capable of setting and operating the timing.

3. The multi-function laser pointer mouse of claim 1, wherein the volume control buttons are placed on the side of the main body.

4. The multi-function laser pointer mouse of claim 1, wherein the multi-function laser pointer mouse further comprises:
a power switch button placed on the side of the main body.

5. The multi-function laser pointer mouse of claim 1, wherein the left button, the right button and the cursor controller are capable of operating the multi-function laser pointer mouse as a mouse.

6. The multi-function laser pointer mouse of claim 1, wherein the multi-function laser pointer mouse further comprises:
a laser diode placed on the main body and capable of emitting a laser beam; and
a laser switch button placed on the center position of the document scrolling control button of the main body and capable of controlling the laser diode if said laser diode emits the laser beam.

7. The multi-function laser pointer mouse of claim 1, wherein the cursor controller comprises a multi-direction arrow key switch.

8. The multi-function laser pointer mouse of claim 1, wherein the cursor controller comprises a trackball.

9. The multi-function laser pointer mouse of claim 1, wherein the brief control buttons are capable of controlling the displaying of a document.

10. The multi-function laser pointer mouse of claim 1, wherein the main body further comprises a space capable of storing a wireless receiver of the multi-function laser pointer mouse.

11. The multi-function laser pointer mouse of claim 1, wherein the volume control button comprises:
a volume up button;
a volume down button; and
a mute button.

12. The multi-function laser pointer mouse of claim 2, wherein the display screen further is capable of showing the remaining battery capacity signal.

13. A multi-function laser pointer mouse comprising:
a main body;
a left button and a right button placed on the front side of main body;
a cursor controller placed near the lower middle position between the left button and the right button of the main body;
at least one document scrolling control button placed near the lower position of the cursor controller of the main body;
a sound output connecter placed on the main body;
an internal microphone;
a recorder button placed on the main body and capable of starting a sound recording function; and
a memory capable of storing a received sound signal recorded by the recording function of the multi-function laser pointer mouse.

14. The multi-function laser pointer mouse of claim 13, wherein the multi-function laser pointer mouse further comprises:
at least one volume control button placed on the main body.

15. The multi-function laser pointer mouse of claim 13, wherein the multi-function laser pointer mouse further comprises:
a display screen capable of displaying timing.
at least one timing function control button capable of setting and operating the timing function.

16. The multi-function laser pointer mouse of claim 13, wherein the multi-function laser pointer mouse further comprises:
a power switch button.

17. The multi-function laser pointer mouse of claim 13, wherein the left button and the right button and the cursor controller are capable of operating the multi-function laser pointer mouse as a mouse.

18. The multi-function laser pointer mouse of claim 13, wherein the multi-function laser pointer mouse further comprises:
a laser diode placed on the main body and capable of emitting a laser beam;
a laser switch button placed on the center position of the brief control buttons of the main body and capable of controlling the laser diode if said laser beam emits the laser beam.

19. The multi-function laser pointer mouse of claim 13, wherein the cursor controller comprises a multi-direction arrow key switch.

20. The multi-function laser pointer mouse of claim 13, wherein the cursor controller comprises a trackball.

21. The multi-function laser pointer mouse of claim 13, wherein the document scrolling control buttons are capable of controlling the displaying of a document.

22. The multi-function laser pointer mouse of claim 13, wherein the main body further comprises a space capable of storing the wireless receiver of the multi-function laser pointer mouse.

23. The multi-function laser pointer mouse of claim 14, wherein the volume control buttons comprise:
a volume up button;
a volume down button; and
a mute button.

24. The multi-function laser pointer mouse of claim 15, wherein the display screen is capable of showing a remaining battery capacity signal.

25. The multi-function laser pointer mouse of claim 13, wherein the multi-function laser pointer mouse further comprises:
an internal digital camera.

26. The multi-function laser pointer mouse of claim 13, wherein the multi-function laser pointer mouse further comprises:
a USB connecter.
